(19) United States
(12) Patent Application Publication
(10) Pub. No.: US 2015/0219978 A1
(43) Pub. Date: Aug. 6, 2015

(54) DISPLAY DEVICE

(71) Applicant: Sharp Kabushiki Kaisha, Osaka (JP)

(72) Inventor: Hiroyuki Moriwaki, Osaka (JP)

(73) Assignee: Sharp Kabushiki Kaisha, Osaka (JP)

(21) Appl. No.: 14/421,542

(22) PCT Filed: Aug. 23, 2013
(86) PCT No.: PCT/JP2013/072599

§ 371 Date: Feb. 13, 2015

(30) Foreign Application Priority Data
Aug. 28, 2012 (JP) 2012-188003

(51) Int. Cl. G02F 1/167; G09G 3/34; G02F 1/1333; G09G 3/20

(52) U.S. Cl. CPC G02F 1/167; G09G 3/2003; G09G 3/3446; G02F 1/133348; G02F 2001/1678

(57) ABSTRACT

The present invention provides an electrophoretic display device provided with a first electrode, a second electrode, and a third electrode disposed oppositely to the first electrode as electrodes for controlling the migration of white charged particles and black charged particles. The present display device can achieve satisfactory color display with high color purity and brightness without reduced reflectance when displaying white.

### TECHNICAL FIELD

The present invention relates to a display device capable of displaying color.

### BACKGROUND ART

In electrophoretic display devices, a prescribed voltage is applied to electrodes to cause charged particles (charged flakes) dispersed in a medium (an insulating liquid) to migrate as appropriate to form the desired display image. In quick-response liquid powder display (QR-LPD) devices, a prescribed voltage is applied to electrodes to cause charged particles (charged flakes) dispersed in a gas to migrate as appropriate to form the desired display image.

In recent years, these display technologies have attracted attention because they can provide a paper-like viewing experience. By using oppositely charged white and black particles as the charged particles, the display device can be made reflective, negating the need for polarizing plates and allowing a particularly high white reflectance to be achieved.

For example, the Japanese Translation of PCT International Application Publication No. 2004-500583 discloses a microcapsule scheme commercialized by the E Ink Corporation and featured in products such as the Kindle. In this scheme, white charged particles and black charged particles charged in advance with different respective polarities are dispersed in an insulating liquid contained in transparent capsules 10-100 μm in diameter. By applying electric fields to the capsules using external electrodes, the charged particles can be made to migrate up or down in the capsules, thereby forming the desired display image.

Next, Japanese Patent Application Laid-Open Publication No. 2003-255401 and Japanese Patent Application Laid-Open Publication No. 2010-256560 disclose the quick-response liquid powder display (QR-LPD) technology commercialized by the Bridgestone Corporation and featured in products such as the Aerobee. This QR-LPD technology uses a gas as the dispersion medium in cells to achieve faster response times and enable display of video content.

In addition, the Japanese Translation of PCT International Application Publication No. 2003-526817 discloses an electrophoretic display device developed by SiPix Inc. that employs a microcup scheme.

These display devices utilize white charged particles to allow a high reflectance to be achieved during display of black and white images. In order to display color images, however, a color filter must be applied separately to the viewer-side substrate. This typically reduces the reflectance of the display.

Patent Document 1 discloses an in-plane electrophoretic display device 100 (shown in FIG. 23) that aims to solve this problem.

As shown in the left microcell enclosed by ribs 107 in FIG. 23(a), a color reflector 108R is provided on a rear substrate 105 that is disposed oppositely to a viewer-side substrate 101. A pair of parallel electrodes 106a and 106b are provided on the surface of the rear substrate 105. Applying a voltage to these electrodes causes oppositely charged white and black particles 110 and 111 to migrate theretowards, thereby creating an aperture above the reflector 108R through which a red color can be displayed.

Next, as shown in the right microcell enclosed by ribs 107 in FIG. 23(a), in order to display black, a prescribed voltage is applied to an electrode 102 provided on the viewer-side substrate 101 to make the black particles 111 migrate towards the electrode 102.

The portions enclosed by the ribs 107 are microcells, and the viewer-side substrate 101 and the rear substrate 105 are fixed together using a sealing material.

This display device 100 can display color without suffering reduced reflectance when displaying white.

### RELATED ART DOCUMENT

### Patent Document

Patent Document 1: Japanese Patent Application Laid-Open Publication, “Japanese Patent Application Laid-Open Publication No. 2005-031345 (Published on Feb. 3, 2005)”

### SUMMARY OF THE INVENTION

### Problems to be Solved by the Invention

However, the display device 100 disclosed in Patent Document 1 suffers from the following problem. As shown in FIGS. 23(a) and 23(b), when displaying color, white and black particles 110 and 111 gather near the in-plane pair of electrodes 106a and 106b. The white and black particles 110 and 111 partially cover the reflector 108R, leaving only a small aperture thereabove. Sufficient color purity and brightness cannot be achieved through this small aperture, and therefore the display device as a whole cannot provide satisfactory color display.

The present invention was made in view of such problems, and aims to provide a display device that exhibits high color purity and brightness and with which satisfactory color display can be achieved without reduced reflectance when displaying white.

### Means for Solving the Problems

In order to solve the abovementioned problems, the present display device includes:

a first substrate;

a second substrate facing the first substrate; and

a cell filled with an insulating medium between the first substrate and the second substrate;

wherein the cell includes white and black charged particles having different respective polarities, and

wherein the first substrate and second substrate are both provided with electrodes for controlling migration of the charged particles,

wherein the electrodes for controlling the migration of the charged particles include a first electrode, a second electrode, and a third electrode,

wherein the first electrode and the second electrode are controlled independently of one another and are both disposed on one of either the first substrate or the second substrate, and

wherein the third electrode is disposed on the other substrate from the one of the first substrate or the second substrate on which the first and second electrodes are disposed such that the third electrode overlaps one of either the first electrode or the second electrode in a plan view.

In past technologies, when displaying color, the white and black charged particles gather near the in-plane pair of electrodes. The white and black particles partially cover the reflector for emitting a prescribed color, leaving only a small aperture thereabove. Sufficient color purity and brightness cannot be achieved through this small aperture, and therefore the display device as a whole cannot provide satisfactory color display.

In the configuration of the present invention described above, the first electrode and the second electrode are both disposed on either the first substrate or the second substrate, and the third electrode is disposed on the opposite substrate from the substrate on which the first and second electrodes are disposed, such that the third electrode overlaps one of either the first electrode or the second electrode when viewed in a plan view. These electrodes make it possible to create electric fields between the substrates.

As a result, the space in between the substrates can be used to gather the white and black charged particles without spreading them widely across the plane between the substrates.

Moreover, by taking advantage of the electric potential between the electrodes that overlap with each other and the electrode that does not overlap with the other electrodes when viewed in a plan view, this configuration makes it easier to move the particles above the aperture towards the opposing electrodes.

This makes it possible to increase the aperture ratio and thereby provide a display device that exhibits high color purity and brightness and with which satisfactory color display can be achieved without reduced reflectance when displaying white.

### Effects of the Invention

As described above, the present display device includes electrodes for controlling the migration of the charged particles. These electrodes include a first electrode, a second electrode, and a third electrode. The first electrode and the second electrode can be controlled independently of one another and are both disposed on either the first substrate or the second substrate. The third electrode is disposed on the opposite substrate from the substrate on which the first and second electrodes are disposed, such that the third electrode overlaps one of either the first electrode or the second electrode when viewed in a plan view.

This makes it possible to provide a display device that exhibits high color purity and brightness and with which satisfactory color display can be achieved without reduced reflectance when displaying white.

### BRIEF DESCRIPTION OF THE DRAWINGS

FIG. 1 schematically shows a configuration of a quick-response liquid powder display device according to Embodiment 1 of the present invention. FIG. 1 also shows a cell emitting red light and displaying white in the areas around the region emitting red light.

FIG. 2 shows the quick-response liquid powder display device according to Embodiment 1 of the present invention as shown in FIG. 1 from the perspective of a viewer.

FIG. 3 schematically shows the configuration of a transistor element for controlling the first electrode and another transistor element for controlling the second electrode of the quick-response liquid powder display device according to Embodiment 1 of the present invention.

FIG. 4 is a plan view showing the quick-response liquid powder display device according to Embodiment 1 of the present invention as shown in FIG. 3 from the perspective of a viewer.

FIG. 5 is a plan view illustrating how a rib arranged on the third electrode (the opposite electrode) overlaps with the first electrode of the quick-response liquid powder display device according to Embodiment 1 of the present invention.

FIG. 6 shows a cell emitting red light and displaying black in the areas around the region emitting red light in the quick-response liquid powder display device according to Embodiment 1 of the present invention.

FIG. 7 shows the quick-response liquid powder display device according to Embodiment 1 of the present invention as shown in FIG. 6 from the perspective of a viewer.

FIG. 8 shows a cell displaying white in the quick-response liquid powder display device according to Embodiment 1 of the present invention.

FIG. 9 shows the quick-response liquid powder display device according to Embodiment 1 of the present invention as shown in FIG. 8 from the perspective of a viewer.

FIG. 10 shows a cell displaying black in the quick-response liquid powder display device according to Embodiment 1 of the present invention.

FIG. 11 shows the quick-response liquid powder display device according to Embodiment 1 of the present invention as shown in FIG. 10 from the perspective of a viewer.

FIG. 12 provides an example of a process for manufacturing an array substrate for the quick-response liquid powder display device according to Embodiment 1 of the present invention.

FIG. 13 provides an example of a process for manufacturing the opposite substrate for the quick-response liquid powder display device according to Embodiment 1 of the present invention.

FIG. 14 schematically shows a configuration of a quick-response liquid powder display device according to Embodiment 2 of the present invention.

FIG. 15 schematically shows a configuration of an electrophoretic display device according to Embodiment 3 of the present invention.

FIG. 16 schematically shows a configuration of a quick-response liquid powder display device according to Embodiment 4 of the present invention.

FIG. 17 shows a cell displaying black in the quick-response liquid powder display device according to Embodiment 4 of the present invention.

FIG. 18 schematically shows a configuration of an electrophoretic display device according to Embodiment 5 of the present invention.

FIG. 19 shows an alternate electrophoretic display device according to Embodiment 5 of the present invention in which each cell is formed by halves of two microcapsules.

FIG. 20 schematically shows a configuration of an electrophoretic display device according to Embodiment 6 of the present invention.

FIG. 21 schematically shows a configuration of a quick-response liquid powder display device according to Embodiment 7 of the present invention.

FIG. 22 schematically shows a configuration of an electrophoretic display device according to Embodiment 8 of the present invention.

FIG. 23 schematically shows a configuration of a conventional electrophoretic display device disclosed in Patent Document 1.

### DETAILED DESCRIPTION OF EMBODIMENTS

Embodiments of the present invention will be described in detail below with reference to figures. However, characteristics of these embodiments such as the dimensions, materials, shapes, and relative arrangements of components described below are intended only as examples. The present invention shall not be interpreted as being limited to these examples.

### Embodiment 1

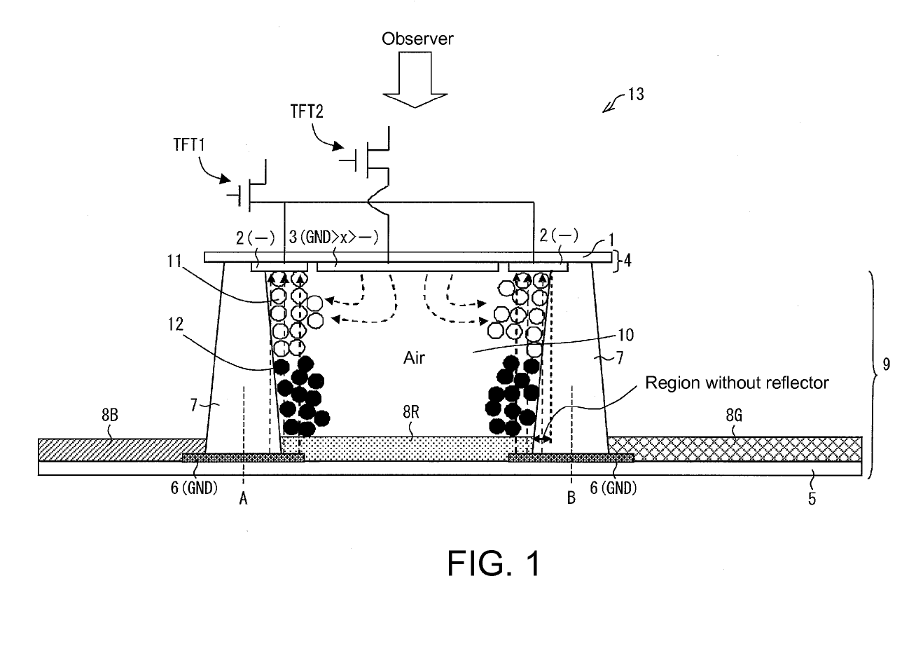

Embodiment 1 of the present invention will be described below with reference to FIGS. 1 to 13.

FIG. 1 schematically shows a configuration of a quick-response liquid powder display device 13. FIG. 1 also shows a cell 10 emitting red light and displaying white in the areas around the region emitting red light.

As shown in FIG. 1, an array substrate 4 includes a transparent substrate 1 on which a first electrode 2 and second electrode 3 are provided for each cell 10. The first electrode 2 and second electrode 3 are independently controllable.

Furthermore, the array substrate 4 includes a transistor element TFT1 for controlling the first electrode 2 and a transistor element TFT2 for controlling the second electrode 3 in each cell 10.

Moreover, in the present embodiment, a flexible substrate can be used for the transparent substrate 1 in order to make the quick-response liquid powder display device 13 flexible. However, if a flexible display device is not required, a glass substrate or the like can be used for the transparent substrate 1.

Next, in the present embodiment the first electrode 2 and the second electrode 3 can be formed using a material that transmits visible light such as indium tin oxide (ITO) or indium zinc oxide (IZO).

Meanwhile, an opposite substrate 9 includes a transparent substrate 5 on which a third electrode (opposite electrode) 6 is formed in a frame shape that, when viewed in a plan view, overlaps the first electrode 2 which is itself formed in a frame shape that encloses the second electrode 3.

Next, a frame-shaped rib (barrier wall) 7 is formed so as to cover the center portion of the frame-shaped third electrode (opposite electrode) 6, thereby forming the cell 10.

Because the rib 7 only covers the center portion of the third electrode (opposite electrode) 6, a portion of the third electrode (opposite electrode) 6 is exposed in the cell 10. This exposed portion of the third electrode (opposite electrode) 6 overlaps the first electrode 2 when viewed in a plan view.

Next, color reflectors 8R, 8G, and 8B, which each reflect light of a prescribed range of wavelengths, are provided on the transparent substrate 5 in the cell 10 formed by the rib 7.

As shown in FIG. 1, the cell 10 is provided with the color reflector 8R that reflects red light. The cell 10 neighbors an adjacent cell provided with the color reflector 8G that reflects green light as well as another adjacent cell provided with the color reflector 8B that reflects blue light.

In other words, in the quick-response liquid powder display device 13, the cell 10 reflects red light and is positioned adjacent to a cell that reflects green light and a cell that reflects blue light.

The colors reflected by the color reflectors as well as the pattern in which the color reflectors are arranged are not particularly limited and can be configured as appropriate.

Next, in the present embodiment, the cell 10 is filled with air as the insulating medium, and positively charged white charged particles 11 and negatively charged black charged particles 12 are inserted in the cell 10.

The white charged particles 11 are formed using titanium oxide and a charge control agent. The black charged particles 12 are formed using carbon black and a charge control agent.

Moreover, in the present embodiment the white charged particles 11 are given a positive charge and the black charged particles 12 are given a negative charge. However, the present invention is not limited to this charging scheme, and the white charged particles 11 and black charged particles 12 may also be charged in the opposite manner.

In the present embodiment, a flexible substrate can be used for the transparent substrate 5 in order to make the quick-response liquid powder display device 13 flexible. However, if a flexible display device is not required, a glass substrate or the like can be used for the transparent substrate 5.

Moreover, the third electrode (opposite electrode) 6 can be formed using a material that transmits visible light such as indium tin oxide (ITO) or indium zinc oxide (IZO). When the display device 13 is a reflective quick-response liquid powder display device, however, the third electrode (opposite electrode) 6 does not need to be formed using a transparent electrode that transmits visible light.

Moreover, an acrylic photoresist with high transmittance of visible light can be used for the rib 7, for example, but other materials can also be used.

This ensures that improved color brightness can be achieved when displaying white in the areas around the region that reflects red light.

As shown in FIG. 1, in this case a negative electric potential is applied to the first electrode 2 in order to make the positively charged white charged particles 11 gather near the array substrate 4.

Meanwhile, the third electrode (opposite electrode) 6 is grounded to give it a relatively positive electric potential in order to make the negatively charged black charged particles 12 gather near the opposite substrate 9.

Next, the second electrode 3 is given an electric potential in between the electric potential of the first electrode 2 and the electric potential of the third electrode (opposite electrode) 6, such that the second electrode 3 has a positive electric potential relative to the first electrode 2. This more reliably moves any white charged particles 11 and black charged particles 12 remaining in the center area of the cell towards the region in which the first electrode 2 and the third electrode (opposite electrode) 6 overlap when viewed in a plan view.

This configuration utilizes the space in between the substrates 4 and 9 to gather the white charged particles 11 and the black charged particles 12 without spreading them widely across the plane between the substrates 4 and 9.

Moreover, by taking advantage of the electric potential between the second electrode 3 that does not overlap with the other electrodes in a plan view and the first electrode 2 and third electrode (opposite electrode) 6 that do overlap with each other in a plan view, this configuration makes it easier to move any white charged particles 11 and black charged particles 12 remaining in the center area of the cell towards the region in which the first electrode 2 and the third electrode (opposite electrode) 6 overlap when viewed in a plan view.

This makes it possible to provide a quick-response liquid powder display device 13 that exhibits high color purity and brightness and with which satisfactory color display can be achieved without reduced reflectance when displaying white.

Moreover, as shown in FIG. 1, in the present embodiment the cross-section of rib 7 gets smaller moving in the direction towards the viewer (that is, towards the array substrate 4).

In this configuration, the rib 7 has a tapered shape, which allows the white charged particles 11 and the black charged particles 12 to be present above the regions in which the color reflectors 8R, 8G, and 8B are not present. This enables an increased aperture ratio to be achieved when displaying white and black.

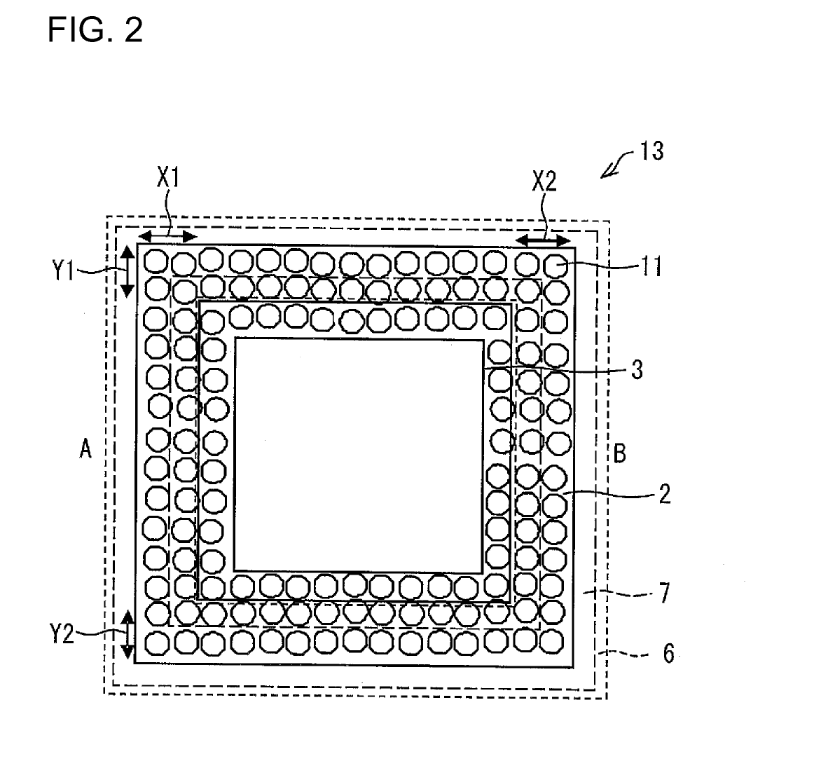

FIG. 2 shows the quick-response liquid powder display device 13 from the perspective of a viewer when the cell is emitting red light and displaying white in the areas around the region emitting red light.

As shown in FIG. 2, the region in which the second electrode 3 is formed reflects red light, and the areas around that region display white.

It should be noted that in FIG. 2, the dimensions X1, X2, Yl, and Y2 indicate the width of the overlapping portions of the first electrode 2 and the exposed portion of the third electrode (opposite electrode) 6 when viewed in a plan view.

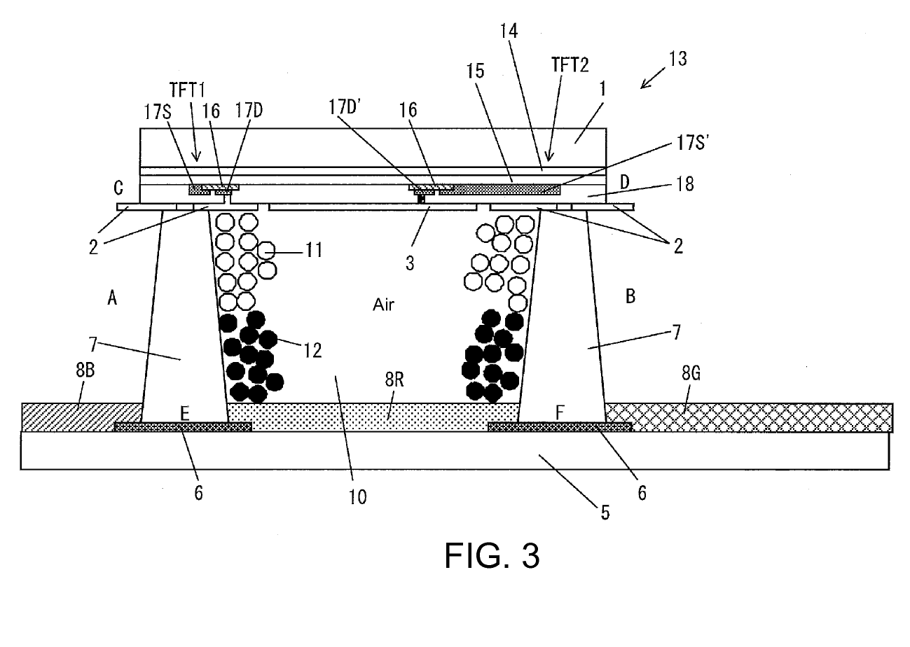

FIG. 3 schematically shows the configuration of a transistor element TFT1 for controlling the first electrode 2 and a transistor element TFT2 for controlling the second electrode 3 of the quick-response liquid powder display device 13.

As shown in FIG. 3, the array substrate 4 shown in FIG. 1 includes a transistor element TFT1 for controlling the first electrode 2 and a transistor element TFT2 for controlling the second electrode 3 in each cell 10.

A gate electrode 14, a gate insulation film 15, and an oxide semiconductor layer 16 (an indium gallium zinc oxide layer, for example) are layered in order on a transparent substrate 1.

In the region in which the transistor element TFT1 is formed, source and drain electrodes 17S and 17D on the oxide semiconductor layer 16 are connected to an interlayer insulating film 18, and the first electrode 2 and the drain electrode 17D are electrically connected through a contact hole formed in the interlayer insulating film 18.

Meanwhile, in the region in which the transistor element TFT2 is formed, source and drain electrodes 17S′ and 17D′ on the oxide semiconductor layer 16 are connected to the interlayer insulating film 18, and the second electrode 3 and the drain electrode 17D′ are electrically connected through a contact hole formed in the interlayer insulating film 18.

In the present embodiment, the oxide semiconductor layer 16 is used for the semiconductor layer in order to maintain a large aperture and in consideration of power consumption; however, other types of semiconductor layers can be used.

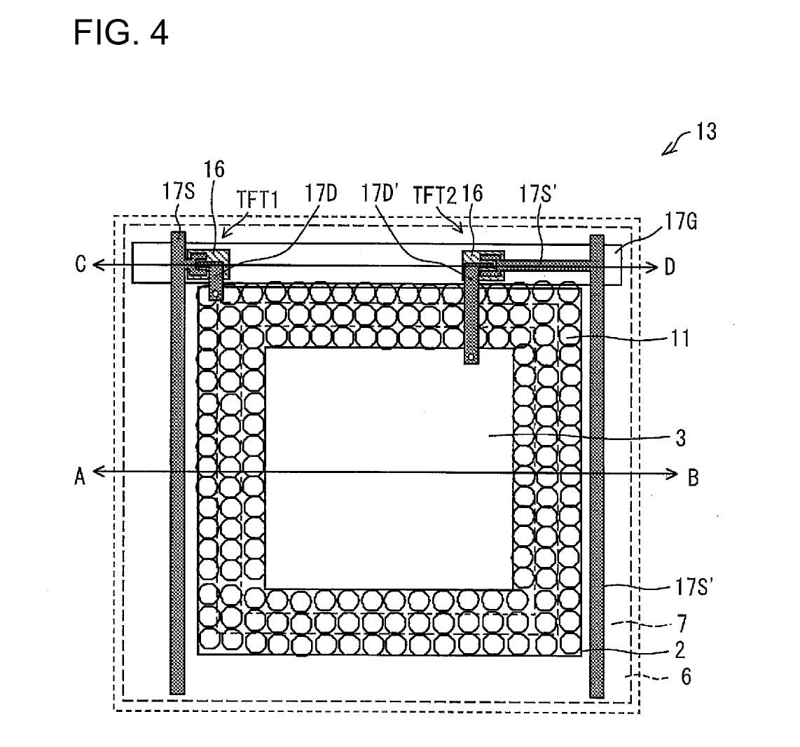

FIG. 4 is a plan view showing the quick-response liquid powder display device 13 as shown in FIG. 3 from the perspective of a viewer.

As shown in FIG. 4, a gate signal line 17G for transistor elements TFT1 and TFT2, a source signal line for transistor element TFT1 that is electrically connected to the drain electrode 17S, and a source signal line for transistor element TFT2 that is electrically connected to the drain electrode 17S′ are arranged to overlap with the rib 7 when viewed in a plan view.

This configuration makes it possible to achieve a large aperture ratio when displaying color as well as to use the signal lines 17G, 17S, and 17S′ as a black mask (black matrix).

Moreover, in consideration of maintaining the aperture ratio, the signal lines 17G, 17S, and 17S′ may be formed using transparent electrodes.

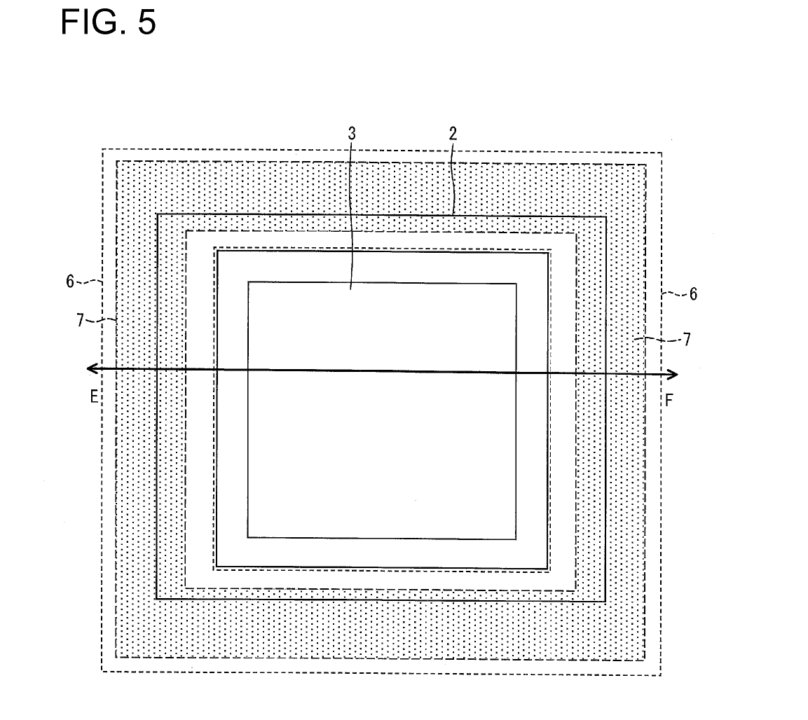

FIG. 5 is a plan view illustrating how the rib 7 arranged on the third electrode (the opposite electrode) 6 overlaps with the first electrode 2.

As shown in FIG. 5, the rib 7 overlaps with the first electrode 2 when viewed in a plan view.

The overlapping portions of the rib 7 and the first electrode 2 form an alignment margin so that the effective electrode area in each cell does not change even if misalignment errors occur when fixing the substrates 4 and 9 to one another.

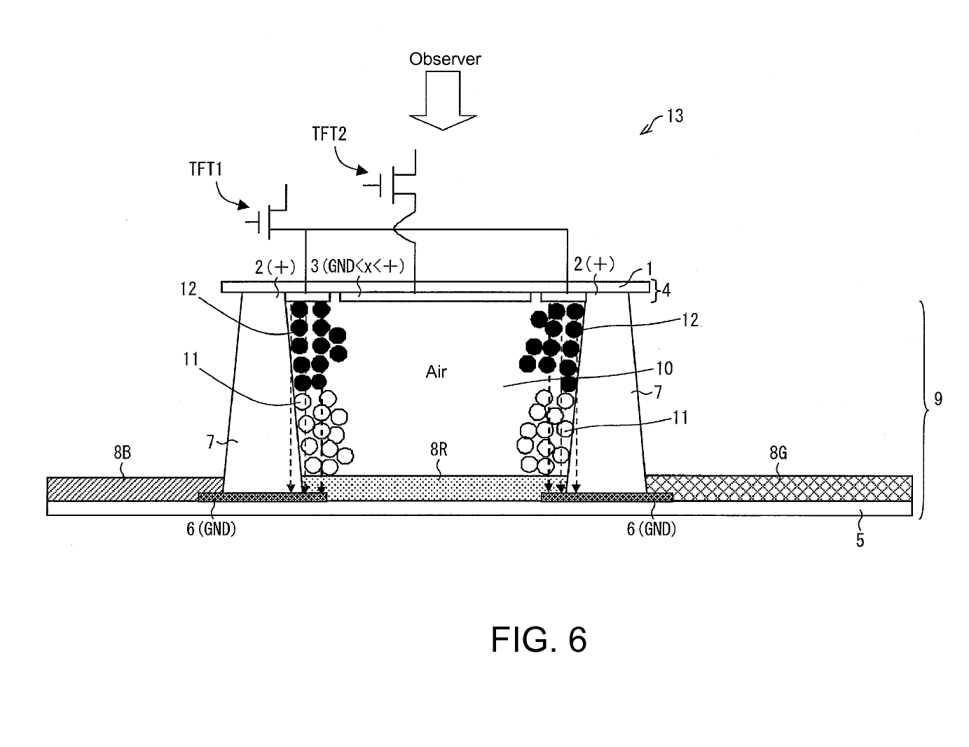

FIG. 6 shows the quick-response liquid powder display device 13 when the cell 10 is emitting red light and displaying black in the areas around the region emitting red light.

As shown in FIG. 6, in this case a positive electric potential is applied to the first electrode 2 in order to make the negatively charged black charged particles 12 gather near the array substrate 4.

Meanwhile, the third electrode (opposite electrode) 6 is grounded to give it a relatively negative electric potential in order to make the positively charged white charged particles 11 gather near the opposite substrate 9.

Next, the second electrode 3 is given an electric potential in between the electric potential of the first electrode 2 and the electric potential of the third electrode (opposite electrode) 6, such that the second electrode 3 has a negative electric potential relative to the first electrode 2. This more reliably moves any white charged particles 11 and black charged particles 12 remaining in the center area of the cell towards the region in which the first electrode 2 and the third electrode (opposite electrode) 6 overlap when viewed in a plan view.

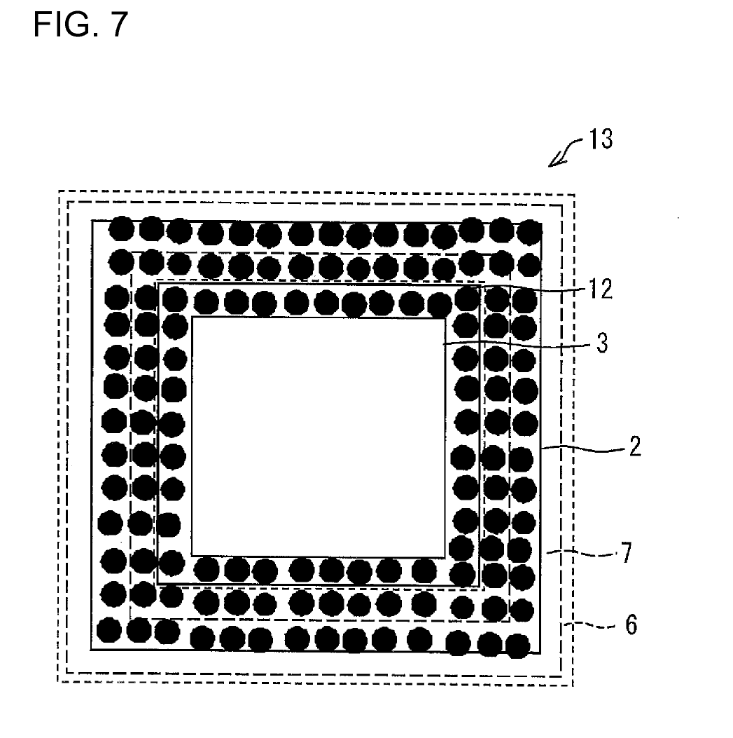

FIG. 7 shows the quick-response liquid powder display device 13 from the perspective of a viewer when the cell is emitting red light and displaying black in the areas around the region emitting red light.

As shown in FIG. 7, the region in which the second electrode 3 is formed reflects red light, and the areas around that region display black.

Displaying color in this manner allows a high color purity to be achieved.

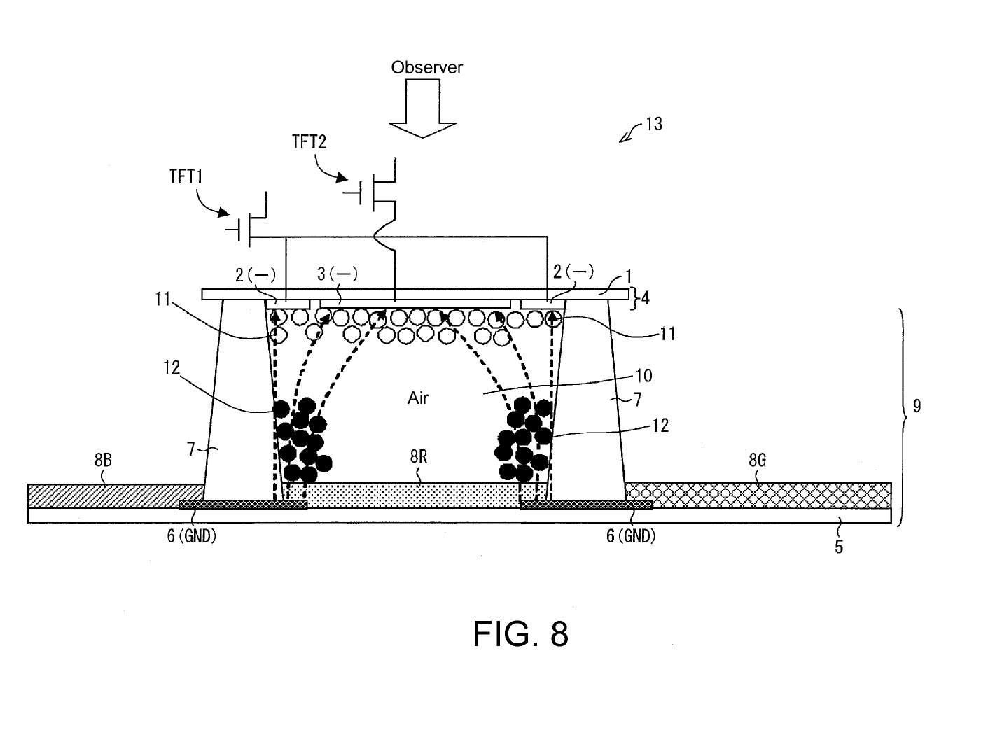

FIG. 8 shows the quick-response liquid powder display device 13 when the cell 10 is displaying white.

As shown in FIG. 8, in this case a negative electric potential is applied to both the first electrode 2 and the second electrode 3 in order to make the positively charged white charged particles 11 gather across the entire surface near the array substrate 4.

Meanwhile, the third electrode (opposite electrode) 6 is grounded to give it a relatively positive electric potential in order to make the negatively charged black charged particles 12 gather near the opposite substrate 9.

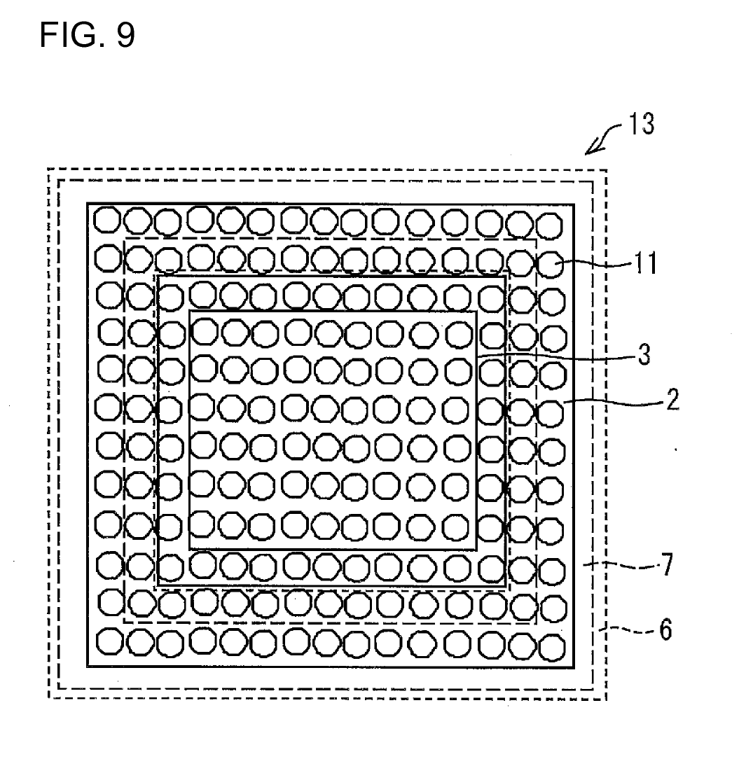

FIG. 9 shows, from the perspective of a viewer, the quick-response liquid powder display device 13 when the cell 10 is displaying white.

As shown in FIG. 9, the cell 10 is displaying white. This allows the quick-response liquid powder display device 13 to have a high reflectance when displaying white.

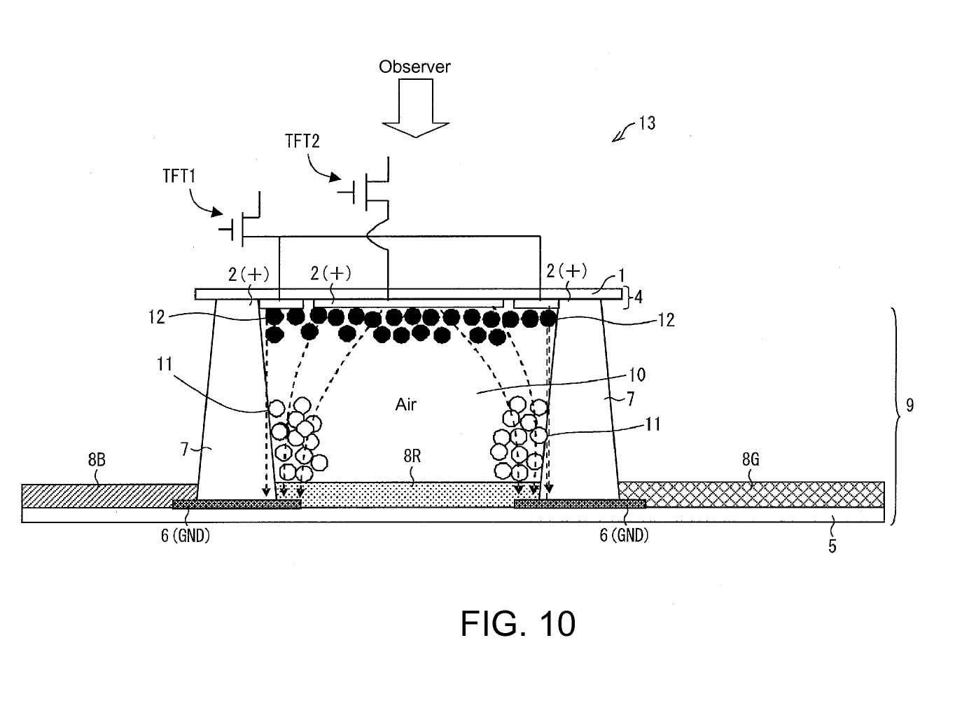

FIG. 10 shows the quick-response liquid powder display device 13 when the cell 10 is displaying black.

As shown in FIG. 10, in this case a positive electric potential is applied to both the first electrode 2 and the second electrode 3 in order to make the negatively charged black charged particles 12 gather across the entire surface near the array substrate 4.

Meanwhile, the third electrode (opposite electrode) 6 is grounded to give it a relatively negative electric potential in order to make the positively charged white charged particles 11 gather near the opposite substrate 9.

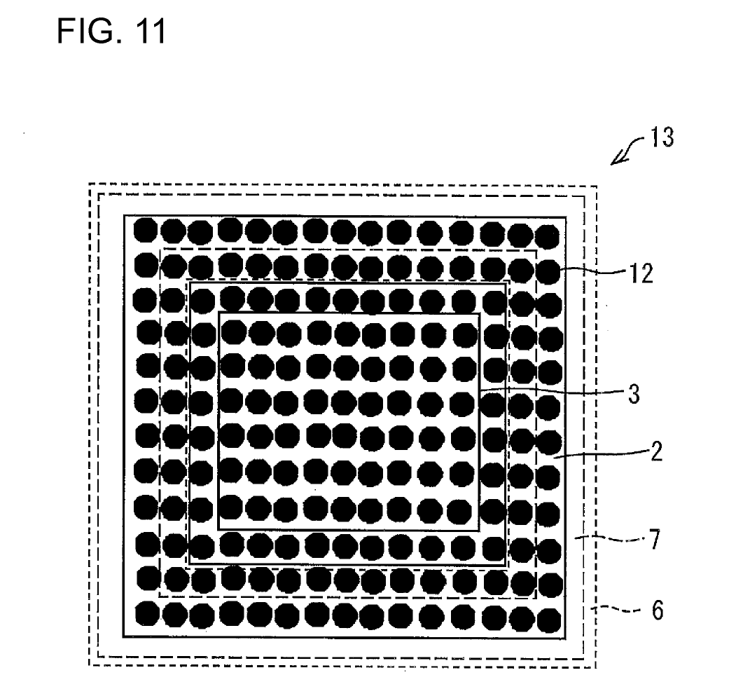

FIG. 11 shows, from the perspective of a viewer, the quick-response liquid powder display device 13 when the cell 10 is displaying black.

As shown in FIG. 11, the cell 10 is displaying black.

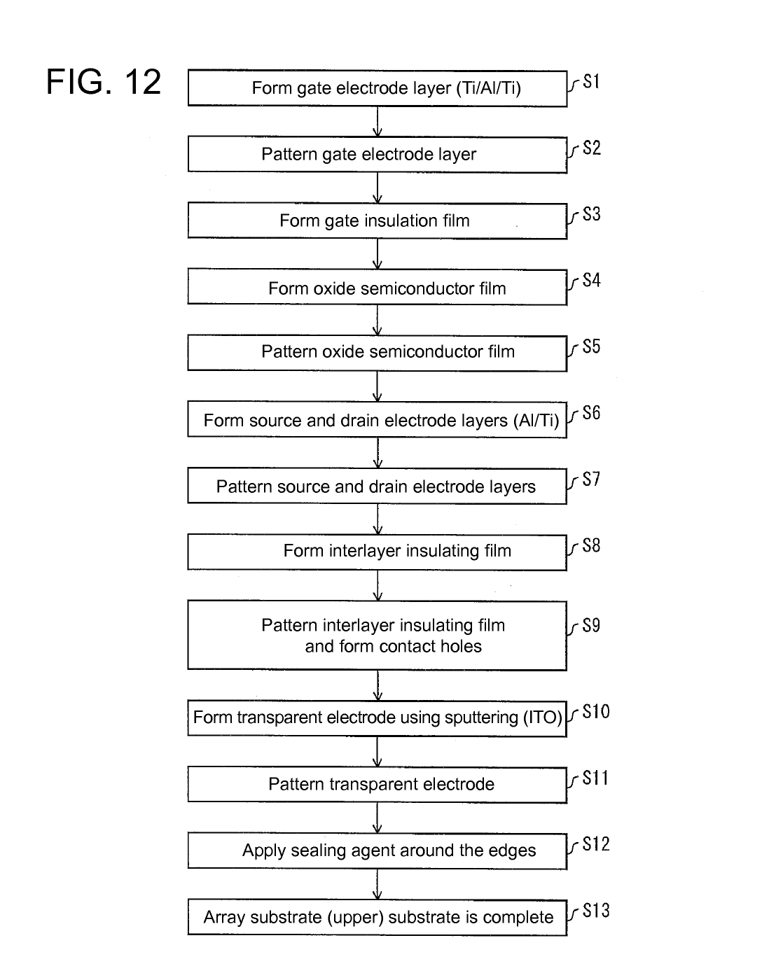

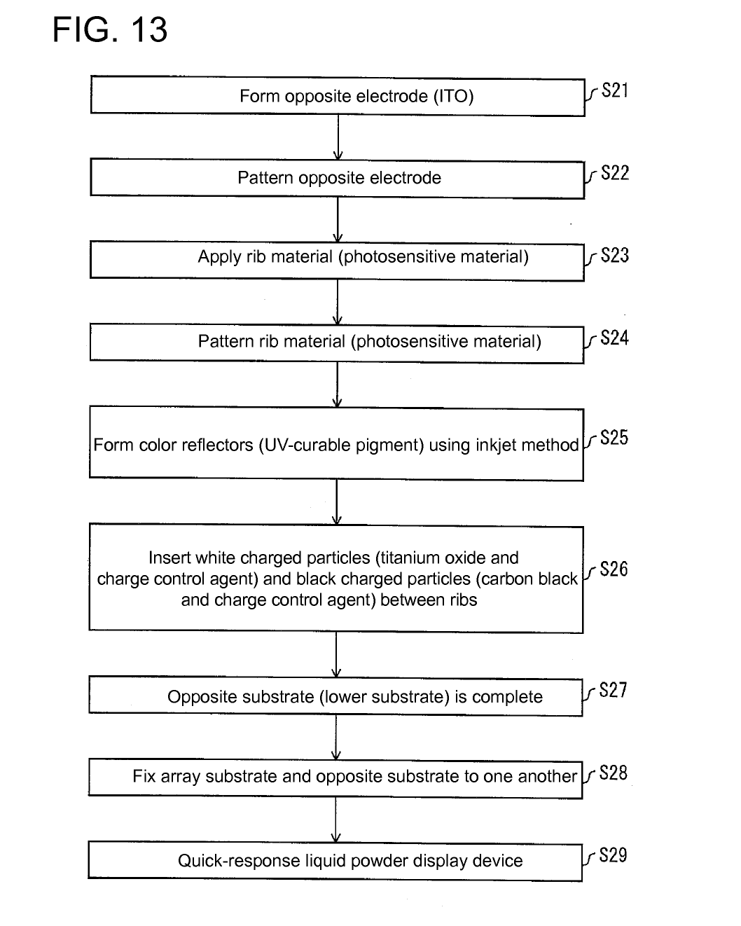

Next, a process for manufacturing the quick-response liquid powder display device 13 will be described below with reference to FIGS. 12 and 13.

FIG. 12 provides an example of a process for manufacturing the array substrate 4 used in the present embodiment.

First, the (Ti/Al/Ti) gate electrode layer 14 is formed on the transparent substrate 1 (S1), and the gate electrode layer 14 is patterned using a photoresist process and an etching process (S2).

Next, the gate insulation film 15 is formed over the entire surface of the gate electrode layer 14 (S3), and the oxide semiconductor layer 16 is formed over the entire surface of the gate insulation film 15 (S4).

Next, the oxide semiconductor layer 16 is patterned using a photoresist process and an etching process (S5).

Then, the source and drain electrode layers 17S, 17D, 17S′, and 17D′ are formed on the entire surface of the oxide semiconductor layer 16 using an Al/Ti multilayer film (S6).

Next, the source and drain electrode layers 17S, 17D, 17S′, and 17D′ are patterned using a photoresist process and an etching process (S7).

Then, the interlayer insulating film 18 is formed on the entire surface of the source and drain electrode layers (S8), and the interlayer insulating film 18 is patterned and the contact holes are formed (S9).

Next, transparent electrodes made from ITO are formed on the interlayer insulating film 18 using sputtering (S10), and the drain electrodes 17D and 17D′ are electrically connected to the transparent electrodes through the contact holes.

Then, the transparent electrodes are patterned, and the first electrode 2 that is electrically connected to the transistor element TFT1 and the second electrode 3 that is electrically connected to the transistor element TFT2 are formed for each cell 10 (S11).

Finally, a sealing agent is applied around the edges of the substrate (S12), and the array substrate 4 is completed (S13).

Meanwhile, FIG. 13 provides an example of a process for manufacturing the opposite substrate 9 used in the present embodiment.

First, the third electrode (opposite electrode) layer is formed on the transparent substrate 5 (S21), and the third electrode (opposite electrode) layer is patterned using a photoresist process and an etching process to form the third electrode (opposite electrode) 6 (S22).

Next, the rib 7 is applied on the third electrode (opposite electrode) 6 (S23), and the rib 7 is patterned using an exposure and development process such that the rib 7 only remains on the center portion of the third electrode (opposite electrode) 6 and such that both edges thereof are exposed (S24).

Then, color reflectors are formed in the region covered by the rib 7 using an inkjet process (S25).

Next, the white charged particles 11 and the black charged particles 12 are inserted in the region covered by the rib 7 (S26), and the opposite substrate 9 is completed (S27).

Finally, the array substrate 4 and the opposite substrate 9 are fixed to one another (S28), and the quick-response liquid powder display device 13 is completed (S29).

### Embodiment 2

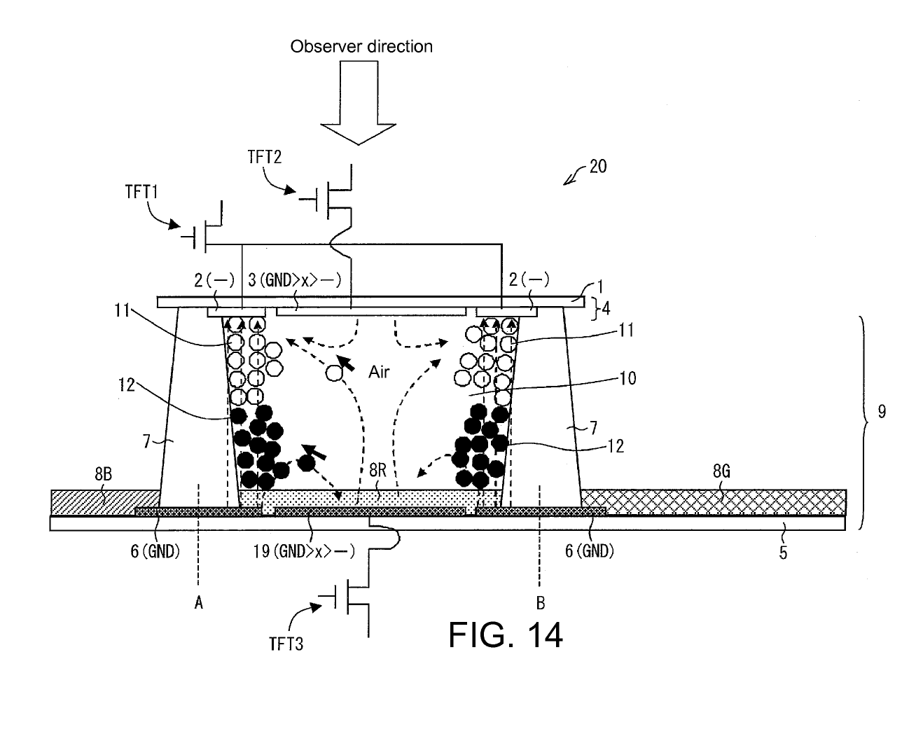

Embodiment 2 of the present invention will be described below with reference to FIG. 14. The present embodiment is identical to Embodiment 1 except in that a fourth electrode 19 is formed on the opposite substrate 9 and disposed oppositely to the second electrode 3. For convenience, the same reference characters are used to indicate the components that have the same functions as the components illustrated in the figures for Embodiment 1, and the description of those components will be omitted here.

FIG. 14 schematically shows a configuration of a quick-response liquid powder display device 20.

As shown in FIG. 14, the third electrode (opposite electrode) 6 is formed in a frame shape and partially covered by the rib 7. On the same plane as the third electrode (opposite electrode) 6, a fourth electrode 19 is disposed oppositely to the second electrode 3.

Next, a transistor element TFT3 for controlling the fourth electrode 19 is provided on the opposite substrate 9.

FIG. 14 shows the quick-response liquid powder display device 20 when the cell 10 is emitting red light and displaying black in the areas around the region emitting red light.

As shown in FIG. 14, in this case a negative electric potential is applied to the first electrode 2 in order to make the positively charged white charged particles 11 gather near the array substrate 4.

Next, the second electrode 3 is given an electric potential in between the electric potential of the first electrode 2 and the electric potential of the third electrode (opposite electrode) 6, such that the second electrode 3 has a positive electric potential relative to the first electrode 2. This more reliably moves any white charged particles 11 remaining in the center area of the cell towards the region in which the first electrode 2 and the third electrode (opposite electrode) 6 overlap when viewed in a plan view.

Meanwhile, the third electrode (opposite electrode) 6 is grounded such that it takes a relatively positive electric potential in order to make the negatively charged black charged particles 12 gather near the opposite substrate 9. The fourth electrode 19 is given an electric potential in between the electric potential of the first electrode 2 and the electric potential of the third electrode (opposite electrode) 6, such that the fourth electrode 19 has a negative electric potential relative to the third electrode (opposite electrode) 6. This more reliably moves any black charged particles 12 remaining in the center area of the cell towards the region in which the first electrode 2 and the third electrode (opposite electrode) 6 overlap when viewed in a plan view.

This configuration allows an even higher aperture ratio to be achieved when the quick-response liquid powder display device 20 displays color.

### Embodiment 3

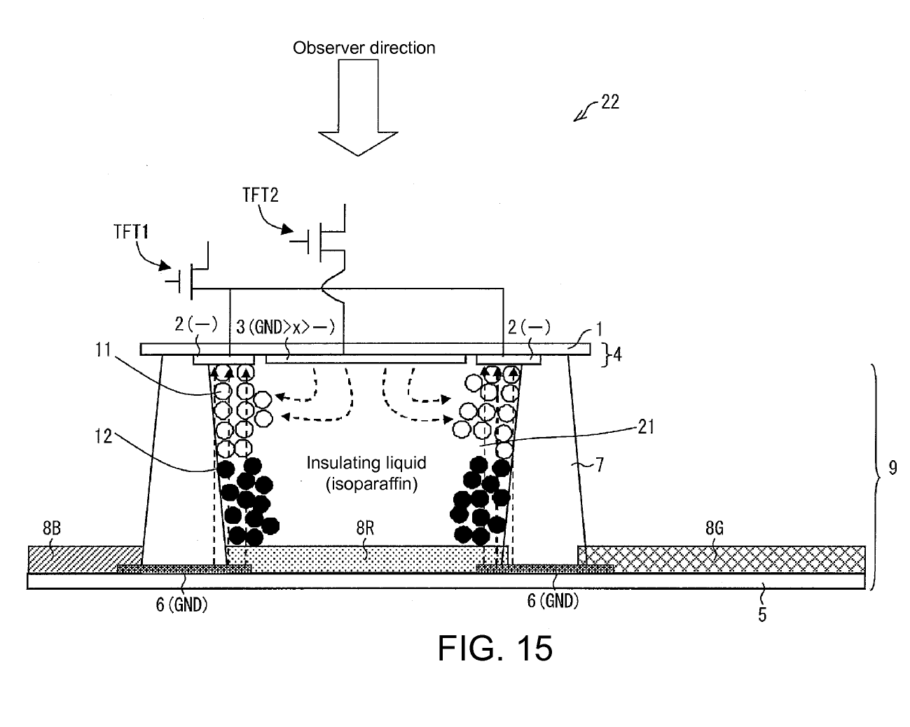

Embodiment 3 of the present invention will be described below with reference to FIG. 15. The present embodiment is identical to Embodiment 1 except in that a cell 21 is filled with an insulating isoparaffin liquid rather than air as the insulating medium. For convenience, the same reference characters are used to indicate the components that have the same functions as the components illustrated in the figures for Embodiment 1, and the description of those components will be omitted here.

FIG. 15 schematically shows a configuration of an electrophoretic display device 22.

FIG. 15 shows the electrophoretic display device 22 when the cell 21 is emitting red light and displaying white in the areas around the region emitting red light.

As shown in FIG. 15, the cell 21 may be filled with an insulating liquid such as isoparaffin as the insulating medium.

### Embodiment 4

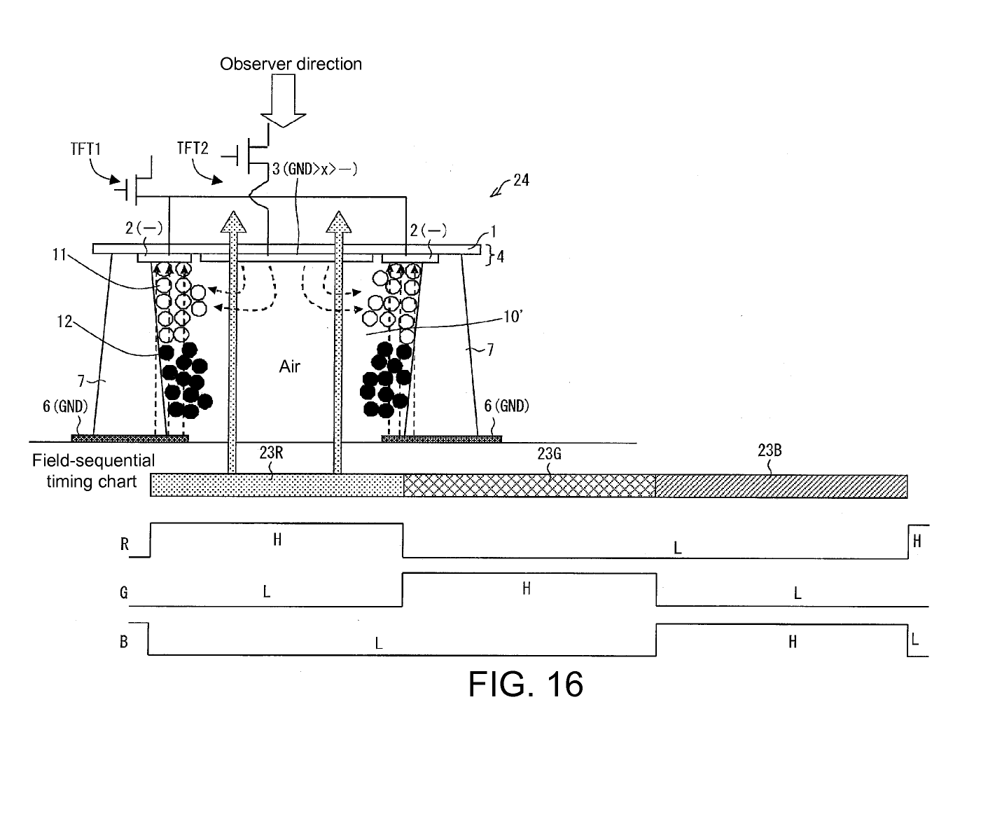

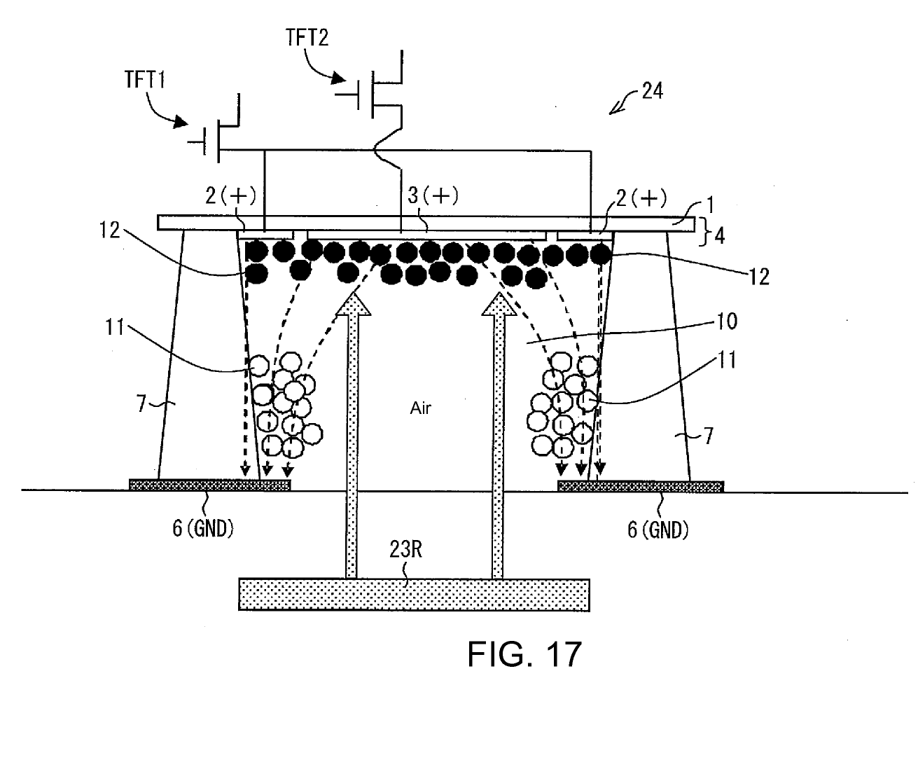

Embodiment 4 of the present invention will be described below with reference to FIGS. 16 and 17. The present embodiment is identical to Embodiment 1 except in that each cell 10 is provided with elements that can emit light of different prescribed ranges of wavelengths at prescribed time intervals rather than with the color reflectors 8R, 8G, and 8B used in Embodiment 1. For convenience, the same reference characters are used to indicate the components that have the same functions as the components illustrated in the figures for Embodiment 1, and the description of those components will be omitted here.

FIG. 16 schematically shows a configuration of a quick-response liquid powder display device 24.

As shown in FIG. 16, each cell 10 is provided with one of three LED elements 23R, 23G, and 23B that are collectively driven in a manner similar to that in a field-sequential system.

The present embodiment is described using the LED elements 23R, 23G, and 23B as examples, but other types of elements can be used in each cell as long as those elements can emit light of different prescribed ranges of wavelengths at prescribed time intervals.

In the quick-response liquid powder display device 24, a fast response time can be achieved because each cell 10 is filled with air as the insulating medium. Also, by virtue of exhibiting this fast response time, the white charged particles 11 and black charged particles 12 can be used as a shutter when driving the three LED elements 23R, 23G, and 23B in a manner similar to that in a field-sequential system to make the LED elements emit light at different prescribed ranges of wavelengths at prescribed time intervals.

FIG. 16 shows the quick-response liquid powder display device 24 when the cell 10 is emitting red light and displaying white in the areas around the region emitting red light.

In this case a negative electric potential is applied to the first electrode 2 in order to make the positively charged white charged particles 11 gather near the array substrate 4.

Meanwhile, the third electrode (opposite electrode) 6 is grounded to give it a relatively positive electric potential in order to make the negatively charged black charged particles 12 gather near the opposite substrate 9.

Next, the second electrode 3 is given an electric potential in between the electric potential of the first electrode 2 and the electric potential of the third electrode (opposite electrode) 6, such that the second electrode 3 has a negative electric potential relative to the first electrode 2. This more reliably moves any white charged particles 11 and black charged particles 12 remaining in the center area of the cell towards the region in which the first electrode 2 and the third electrode (opposite electrode) 6 overlap when viewed in a plan view.

FIG. 17 shows the quick-response liquid powder display device 24 when the cell 10 is displaying black.

As shown in FIG. 17, in this case a positive electric potential is applied to both the first electrode 2 and the second electrode 3 in order to make the negatively charged black charged particles 12 gather across the entire surface near the array substrate 4.

Meanwhile, the third electrode (opposite electrode) 6 is grounded to give it a relatively negative electric potential in order to make the positively charged white charged particles 11 gather near the opposite substrate 9.

Next, as shown in FIG. 17, the LED element 23R is emitting red light into the cell 10, but the white charged particles 11 and black charged particles 12 are used as a shutter to block this red light.

### Embodiment 5

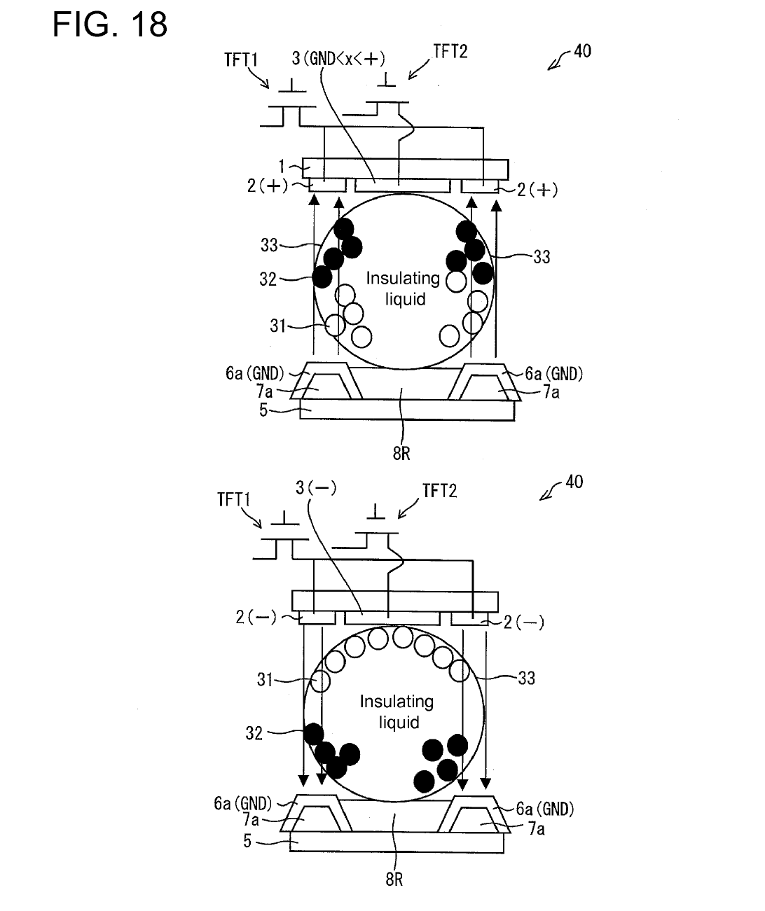

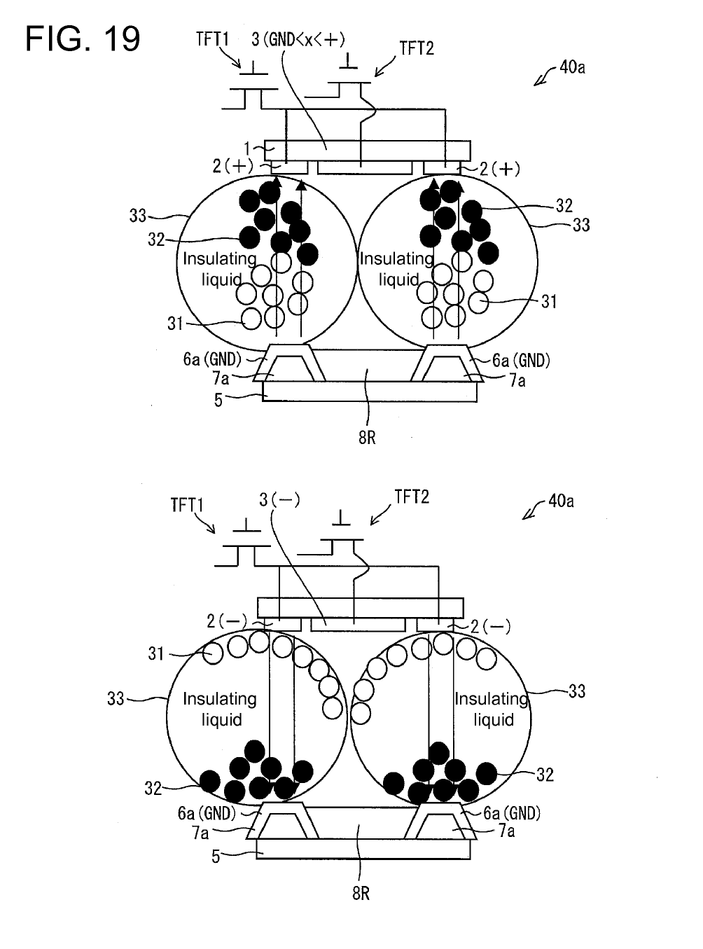

Embodiment 5 of the present invention will be described below with reference to FIGS. 18 and 19. The present embodiment is identical to Embodiments 1 to 4 except in that a microcapsule 33 is used as a cell rather than the cell 10 formed by the rib 7 as in Embodiments 1 to 4. For convenience, the same reference characters are used to indicate the components that have the same functions as the components illustrated in the figures for Embodiment 1 to 4, and the description of those components will be omitted here.

FIG. 18 schematically shows a configuration of an electrophoretic display device 40.

In the present embodiment, an insulating isoparaffin liquid is used for the insulating medium, as in Embodiment 3.

FIG. 18(a) shows the electrophoretic display device 40 when each cell formed by a microcapsule 33 is emitting red light and displaying black in the areas around the region emitting red light.

As shown in FIG. 18(a), in this case a positive electric potential is applied to the first electrode 2 in order to make negatively charged black charged particles 32 gather near a substrate 1, on which the first electrode 2 and second electrode 3 are provided.

Meanwhile, a third electrode (opposite electrode) 6a is grounded to give it a relatively negative electric potential in order to make positively charged white charged particles 31 gather near an opposite substrate 5, on which the third electrode (opposite electrode) 6a is provided.

Next, the second electrode 3 is given an electric potential in between the electric potential of the first electrode 2 and the electric potential of the third electrode (opposite electrode) 6a, such that the second electrode 3 has a negative electric potential relative to the first electrode 2. This more reliably moves any white charged particles 31 and black charged particles 32 remaining in the center area of the cell towards the region in which the first electrode 2 and the third electrode (opposite electrode) 6a overlap when viewed in a plan view.

Moreover, a rib 7a is formed in a tapered shape so that the third electrode (opposite electrode) 6a can be formed on top of the rib 7a; however, the rib 7a in the present embodiment has a different shape than the rib 7 in Embodiments 1 to 4. The height of the rib 7a is set to be lower than the position at which the third electrode (opposite electrode) 6a will be formed.

Meanwhile, FIG. 18(b) shows the electrophoretic display device 40 when each cell formed by a microcapsule 33 is displaying white.

As shown in FIG. 18(b), in this case a negative electric potential is applied to both the first electrode 2 and the second electrode 3 in order to make the positively charged white charged particles 31 gather across the entire surface near the array substrate, on which the first electrode 2 and second electrode 3 are provided.

Meanwhile, the third electrode (opposite electrode) 6 is grounded to give it a relatively positive electric potential in order to make the negatively charged black charged particles 32 gather near the substrate 5.

It should be noted that the arrows in the figures indicate the direction of the electric field applied.

FIG. 19 shows an electrophoretic display device 40a in which each cell is formed by halves of two microcapsules 33.

FIG. 19(a) shows the electrophoretic display device device 40a when each cell is emitting red light and displaying black in the areas around the region emitting red light.

Meanwhile, FIG. 19(b) shows the electrophoretic display device 40a when each cell is displaying white.

As shown in FIGS. 18 and 19, the corresponding display devices can perform satisfactory display without any particular limitation on the positional relationship between the microcapsules and the electrodes (the microcapsules and electrodes may be offset from one another).

### Embodiment 6

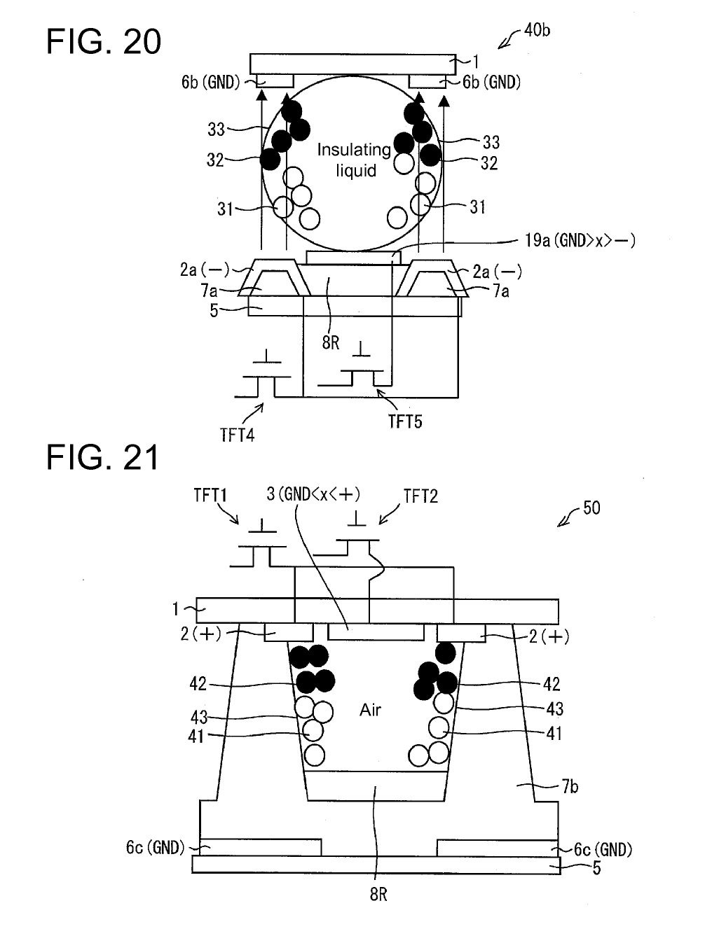

Embodiment 6 of the present invention will be described below with reference to FIG. 20. The present embodiment is identical to Embodiment 5 except in that a first electrode 2a and a second electrode 19a are provided on a substrate 5 and given prescribed electric potentials and in that a third electrode (opposite electrode) 6b is provided on a substrate 1 and electrically grounded. For convenience, the same reference characters are used to indicate the components that have the same functions as the components illustrated in the figures for Embodiment 5, and the description of those components will be omitted here.

FIG. 20 shows an electrophoretic display device 40b when each cell formed by a microcapsule 33 is emitting red light and displaying black in the areas around the region emitting red light.

As shown in FIG. 20, in this case a negative electric potential is applied to the first electrode 2a in order to make the positively charged white charged particles 31 gather near the substrate 5, on which the first electrode 2a and second electrode 19a are provided.

Meanwhile, the third electrode (opposite electrode) 6b provided on the substrate 1 is grounded to give the electrode a relatively positive electric potential in order to make the negatively charged black charged particles 32 gather near the substrate 1.

Next, the second electrode 19a is given an electric potential in between the electric potential of the first electrode 2a and the electric potential of the third electrode (opposite electrode) 6b, such that the second electrode 19a has a positive electric potential relative to the first electrode 2a. This more reliably moves any white charged particles 31 and black charged particles 32 remaining in the center area of the cell towards the region in which the first electrode 2a and the third electrode (opposite electrode) 6b overlap when viewed in a plan view.

It should also be noted that, as shown in FIG. 20, in the present embodiment a transistor element TFT4 for controlling the first electrode 2a and a transistor element TFT5 for controlling the second electrode 19a are provided on the substrate 5.

Moreover, the configuration described for the present embodiment may also be applied as appropriate to other cases in which cells are not formed using microcapsules (Embodiments 1 to 4 and Embodiment 7, for example).

### Embodiment 7

Embodiment 7 of the present invention will be described below with reference to FIG. 21. The present embodiment is identical to Embodiments 1 to 6 except in that the present embodiment uses microcup-shaped cells 43 formed using a substrate 1 and barrier walls formed in the shape of alternating protrusions and recessions on a substrate 5. For convenience, the same reference characters are used to indicate the components that have the same functions as the components illustrated in the figures for Embodiment 1 to 6, and the description of those components will be omitted here.

FIG. 21 shows a quick-response liquid powder display device 50 when the microcup-shaped cell 43 is emitting red light and displaying black in the areas around the region emitting red light.

In the present embodiment, air is used for the insulating medium.

As shown in FIG. 21, in this case a positive electric potential is applied to the first electrode 2 in order to make negatively charged black charged particles 42 gather near the substrate 1, on which the first electrode 2 and second electrode 3 are provided.

Meanwhile, a third electrode (opposite electrode) 6c is grounded to give it a relatively negative electric potential in order to make positively charged white charged particles 41 gather near the opposite substrate 5, on which the third electrode (opposite electrode) 6c is provided.

Next, the second electrode 3 is given an electric potential in between the electric potential of the first electrode 2 and the electric potential of the third electrode (opposite electrode) 6c, such that the second electrode 3 has a negative electric potential relative to the first electrode 2. This more reliably moves any white charged particles 41 and black charged particles 42 remaining in the center area of the cell towards the region in which the first electrode 2 and the third electrode (opposite electrode) 6c overlap when viewed in a plan view.

### Embodiment 8

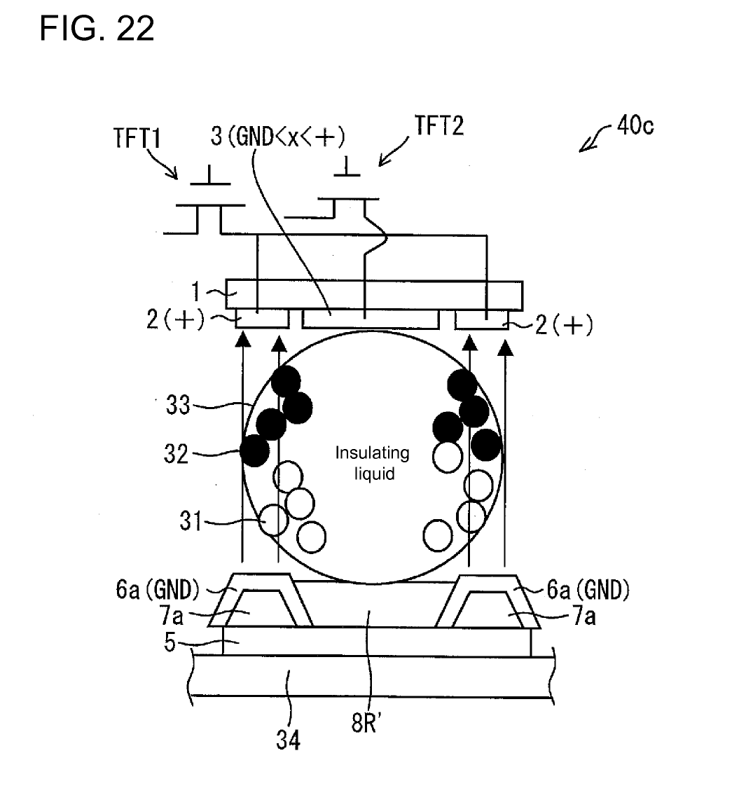

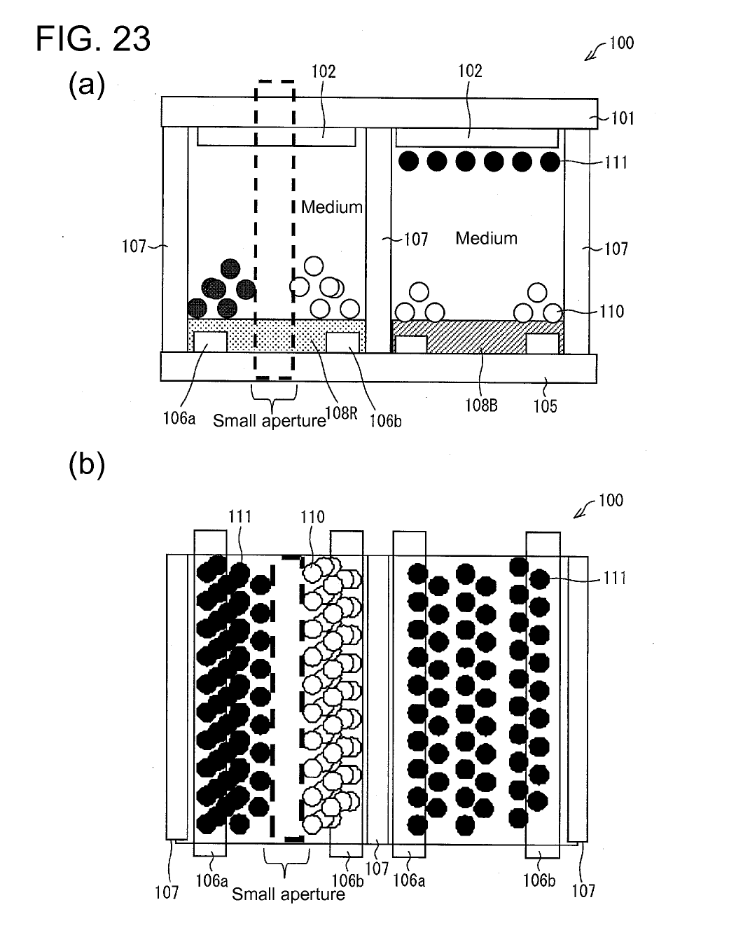

Embodiment 8 of the present invention will be described below with reference to FIG. 22. The present embodiment is identical to Embodiments 1 to 7 except in that the present embodiment uses a backlight 34 and color filters 8R′, 8G′, and 8G′ to emit light of a prescribed range of wavelengths into each cell rather than the color reflectors 8R, 8G, and 8B that reflect light of a prescribed range of wavelengths used in Embodiments 1 to 3 and Embodiments 5 to 7 or the LED elements 23R, 23G, and 23B given as examples in Embodiment 4. For convenience, the same reference characters are used to indicate the components that have the same functions as the components illustrated in the figures for Embodiments 1 to 7, and the description of those components will be omitted here.

FIG. 22 shows an electrophoretic display device 40c when the backlight 34 emits white light through the red color filter 8R′, thereby emitting red light into a cell formed by a microcapsule 33. The cell therefore emits red light, and the areas around the region emitting red light display black.

As shown in FIG. 22, in this case a positive electric potential is applied to the first electrode 2 in order to make negatively charged black charged particles 32 gather near the substrate 1, on which the first electrode 2 and second electrode 3 are provided.

Meanwhile, the third electrode (opposite electrode) 6a is grounded to give it a relatively negative electric potential in order to make positively charged white charged particles 31 gather near the opposite substrate 5, on which the third electrode (opposite electrode) 6a is provided.

Next, the second electrode 3 is given an electric potential in between the electric potential of the first electrode 2 and the electric potential of the third electrode (opposite electrode) 6a, such that the second electrode 3 has a negative electric potential relative to the first electrode 2. This more reliably moves any white charged particles 31 and black charged particles 32 remaining in the center area of the cell towards the region in which the first electrode 2 and the third electrode (opposite electrode) 6a overlap when viewed in a plan view.

Moreover, the configuration described for the present embodiment may also be applied as appropriate to other cases in which cells are not formed using microcapsules (Embodiments 1 to 4 and Embodiment 7, for example).

### SUMMARY

In the present display device, it is preferable that the first electrode be formed to surround the second electrode and that the first electrode and third electrode be arranged to overlap when viewed in a plan view.

This configuration allows white and black charged particles to be gathered between the first electrode and third electrode.

Moreover, when displaying color, adjusting the electric potential of the first electrode and/or third electrode allows white or black to be displayed in the area around the aperture.

Displaying black in the area around the aperture allows improved color purity to be achieved, and displaying white in the area around the aperture allows improved color brightness to be achieved.

In the present display device, it is preferable that a first active element for controlling the first electrode and a second active element for controlling the second electrode be provided on one of the substrates.

This configuration allows the method for manufacturing the substrate on which the first active element and the second active element are formed to be separated from the method for manufacturing the other substrate (on which the third electrode is formed), thereby improving manufacturing yield and takt time.

In the present display device, it is preferable that the semiconductor layer provided for the first active element and the second active element be formed using an oxide layer containing at least one of the following elements: indium, gallium, and zinc.

This composition allows the size of the elements to be reduced and a larger aperture to be achieved in comparison with using other active elements such as those provided using an amorphous semiconductor layer.

Moreover, oxide semiconductor layers exhibit low leakage current and high pixel state retention (memory properties) in the off state, which makes it possible to drive the semiconductors at a lower frequency and thereby reduce power consumption.

In the present display device, it is preferable that the first electrode be formed to align with the edge of the cell and that the first electrode and the edge of the cell overlap partially when viewed in a plan view.

This configuration makes it possible to gather the white and black charged particles along the edges of the cell, thereby allowing a large aperture to be maintained when displaying color.

In the present display device, it is preferable that part of the cell be formed by a barrier wall provided on the opposite substrate.

In this configuration, in which the barrier wall is provided on the opposite substrate (on which the third electrode is formed), the effective electrode area of each cell does not change even if misalignment errors occur when fixing the first substrate and the second substrate to one another because the barrier wall shifts the same amount relative to the first electrode and second electrode provided on the facing substrate.

Moreover, the array process and barrier wall formation process can be separated until the first substrate and second substrate are fixed to one another, thereby improving yield and takt time.

In the present display device, it is preferable that the cross-section of the barrier wall become smaller as the height of the barrier wall increases.

This configuration, in which the cross-section of the barrier wall become smaller as the height of the barrier wall increases, gives the barrier wall a tapered shape, thereby allowing a larger aperture ratio to be achieved when displaying black or white.

In the present display device, it is preferable that the first active element for controlling the first electrode and the second active element for controlling the second electrode be provided on one of the substrates, and that the first active element, second active element, the signal line for the first active element, and the signal line for the second active element all be arranged to overlap with the barrier wall when viewed in a plan view.

This configuration makes it possible to achieve a large aperture ratio when displaying color as well as to use the signal line for the first active element and the signal line for the second active element as a black mask (black matrix).

In the present display device, it is preferable that the signal line for the first active element and the signal line for the second active element be formed using a transparent conductive film that transmits visible light.

This configuration allows a large aperture to be achieved because the signal line for the first active element and the signal line for the second active element are formed using a transparent conductive film that transmits visible light.

In the present display device, it is preferable that the third electrode be formed in a frame shape that lines up with the edge of the cell, and that a fourth electrode be provided in the interior region of the third electrode such that the fourth electrode is disposed oppositely to the second electrode.

Adjusting the electric potential of the fourth electrode makes it possible to more reliably move white and black charged particles away from the region transmitting light of a prescribed range of wavelengths.

In the present display device, it is preferable that a third active element for controlling the fourth electrode be provided on the other substrate.

This configuration allows the method for manufacturing the substrate on which the first active element and the second active element are formed to be separated from the method for manufacturing the other substrate on which the third active element is formed, thereby improving manufacturing yield and takt time.

In the present display device, it is preferable that the third active element and the signal line for the third active element be formed to overlap, when viewed in a plan view, with the barrier wall that forms part of the cell.

This configuration allows a large aperture ratio to be achieved when displaying color.

In the present display device, it is preferable that the semiconductor layer provided for the third active element be formed using an oxide layer containing at least one of the following elements: indium, gallium, and zinc.

This composition allows the size of the element to be reduced and a larger aperture to be achieved in comparison with using other active elements such as those provided using an amorphous semiconductor layer.

Moreover, oxide semiconductor layers exhibit low leakage current and high pixel state retention (memory properties) in the off state, which makes it possible to drive the semiconductors at a lower frequency and thereby reduce power consumption.

In the present display device, a reflective layer for emitting light of a prescribed range of wavelengths from the cell may be provided in the region that overlaps with the cell when viewed in a plan view.

This configuration makes it possible to provide a reflective display device.

Moreover, providing the reflective layer on the other substrate (on which the barrier wall and third electrode are formed) allows the reflective layer to be formed in the interior of the barrier wall of the cell using an inkjet process, for example. This can drastically reduce production time in comparison with using conventional photolithography processes.

In the present display device, the cell may be provided with light-emitting devices that emit light of different prescribed ranges of wavelengths at prescribed time intervals.

This configuration makes it possible to provide a display device equipped with light-emitting devices that can be driven as in a so-called field-sequential system to emit light of different prescribed ranges of wavelengths into the cell at prescribed time intervals.

In the present display device, it is preferable that air be used for the insulating medium.

Using air as the insulating medium makes it possible to provide a quick-response liquid powder display device that exhibits a fast response time.

The present display device may be provided with a backlight and a color filter layer that takes light from the backlight and transmits light of prescribed ranges of wavelengths into the cell.

This configuration makes it possible to provide a backlight-equipped transmissive display device.

In the present display device, the cell may be formed using a microcapsule.

This configuration makes it possible to provide a display device having cells formed using microcapsules.

In the present display device, the cell may be formed using the first substrate, the second substrate, and the barrier wall.

This configuration makes it possible to provide a display device having cells formed using the first substrate, the second substrate, and the barrier wall.

In the present display device, the cell may be formed using one of either the first substrate or the second substrate and barrier walls formed in the shape of alternating protrusions and recessions on the other substrate.

This configuration makes it possible to provide a display device having cells formed using one of either the first substrate or the second substrate and barrier walls formed in the shape of alternating protrusions and recessions on the other substrate.

The present invention is not limited to the embodiments described above, and various modifications can be made without departing from the scope of the claims. Therefore, embodiments obtained by appropriately combining the techniques disclosed in different embodiments are included in the technical scope of the present invention.

### INDUSTRIAL APPLICABILITY

The present invention is suitable for use in quick-response liquid powder display devices and electrophoretic display devices that are capable of displaying color.

### DESCRIPTION OF REFERENCE CHARACTERS

1 transparent substrate
2, 2a first electrode
3, 19a second electrode
4 array substrate
5 transparent substrate
6, 6a third electrode (opposite electrode)
7 rib (barrier wall)
7a rib
8R, 8G, 8B color reflector
8R′, 8G′, 8B′ color filter
9 opposite substrate
10 cell
11, 31, 41 white charged particle
12, 32, 42 black charged particle
13, 20, 22, 24 display device
14 gate electrode
15 gate insulation film
16 oxide semiconductor layer (InGaZnOx layer)
17S, 17D source and drain electrode
17S′, 17D′ source and drain electrode
17G gate signal line
18 interlayer insulating layer
19 fourth electrode
21 cell
23R, 23G, 23B LED element
33 microcapsule
34 backlight
40, 40a, 40b, 40c display device
43 microcup-shaped cell
50 display device
TFT1 transistor element
TFT2 transistor element
TFT3 transistor element
TFT4 transistor element
TFT5 transistor element

1. A display device, comprising:
a first substrate;
a second substrate facing the first substrate; and
a cell filled with an insulating medium between the first substrate and the second substrate;
wherein the cell includes white and black charged particles having different respective polarities, and
wherein the first substrate has a first electrode and a second electrode thereon, and second substrate has a third electrode thereon, the first through the third electrodes being for controlling migration of the charged particles,
wherein the first electrode and the second electrode are controlled independently of one another, and
wherein the third electrode overlaps one of either the first electrode or the second electrode in a plan view.

2. The display device according to claim 1,
wherein the first electrode is formed to surround the second electrode, and
wherein the first electrode and third electrode are arranged to overlap in a plan view.

3. The display device according to claim 2, wherein a first active element for controlling the first electrode and a second active element for controlling the second electrode are provided on said first substrate.

4. The display device according to claim 3, wherein a semiconductor layer provided in the first active element and the second active element is formed using an oxide layer containing at least one of indium, gallium, and zinc.

5. The display device according to claim 2,
wherein the first electrode is formed to align with an edge of the cell, and
wherein the first electrode partially overlaps the edge of the cell in a plan view.

6. The display device according to claim 3, further comprising a barrier wall extending from the second substrate to the first substrate to define a boundary of the cell.

7. The display device according to claim 6, wherein a cross-section of the barrier wall becomes smaller as a height of the barrier wall from the second substrate increases.

8. The display device according to claim 7,
wherein the first active element for controlling the first electrode and the second active element for controlling the second electrode are provided on the first substrate, and
wherein the first active element, the second active element, a signal line for the first active element, and a signal line for the second active element are all arranged to overlap with the barrier wall in a plan view.

9. The display device according to claim 8, wherein the signal line for the first active element and the signal line for the second active element are formed using a transparent conductive film that allows visible light to pass therethrough.

10. The display device according to claim 8,
wherein the third electrode is formed in a frame shape that lines up with an edge of the cell, and
wherein a fourth electrode is provided in an interior region of the third electrode such that the fourth electrode faces the second electrode.

11. The display device according to claim 10, wherein a third active element for controlling the fourth electrode is provided on the second substrate.

12. The display device according to claim 11, wherein the third active element and a signal line for the third active element are formed to overlap with the barrier wall in a plan view.

13. The display device according to claim 11, wherein a semiconductor layer in the third active element is formed using an oxide layer containing at least one of indium, gallium, and zinc.

14. The display device according to claim 1, wherein a reflective layer for emitting light of a prescribed range of wavelengths from the cell is provided in a region that overlaps with the cell in a plan view.

15. The display device according to claim 1, wherein the cell is provided with light-emitting devices that emit light of different prescribed ranges of wavelengths at prescribed time intervals.

16. The display device according to claim 15, wherein air is used as the insulating medium.

17. The display device according to claim 1, further comprising:
a backlight;
a color filter layer for emitting, into the cell, light of prescribed ranges of wavelengths from light from the backlight.

18. The display device according to claim 2, wherein the cell is formed using a microcapsule.

19. The display device according to claim 1, wherein the cell is formed using the first substrate, the second substrate, and a barrier wall.

20. The display device according to claim 1, wherein the cell is formed using a barrier wall formed in a shape of alternating protrusions and recessions provided on the first or second substrate.
